(19) United States
(12) Patent Application Publication
(10) Pub. No.: US 2009/0162593 A1
(43) Pub. Date: Jun. 25, 2009

(54) Mosaic

(76) Inventor: Carmen Kotulla, Stuttgart (DE)

Correspondence Address: Howard IP Law Group, P.O. Box 226, Fort Washington, PA, 19034, US

(21) Appl. No.: 11/579,914

(22) PCT Filed: May 7, 2005
(86) PCT No.: PCT/DE2005/000856

§ 371 Date: Feb. 12, 2009

(30) Foreign Application Priority Data
May 11, 2004 (DE) 10 2004 023 707.7
Jun. 25, 2004 (DE) 10 2004 030 907.8

(51) Int. Cl. E04B 1/00; B44C 3/12

(52) U.S. Cl. 428/39; 156/63

(57) ABSTRACT

The invention relates to a mosaic, especially for walls, ceilings, or floors, comprising a plurality of individual mosaic elements that are spaced apart by means of joints. In order to improve the designing options of said mosaic, light-discharging elements can be disposed in the joints.

### RELATED APPLICATIONS

This application is the national stage application under 35 U.S.C. § 371 of and claims the benefit of Int'l. Application No. PCT/DE2005/000856, filed May 7, 2005, which International Application claims the priority to German Application No. 102004030907.8 filed Jun. 25, 2004, and German Application No. 102004023707.7 filed May 11, 2004, the entire disclosures of which are incorporated herein by reference as if being set forth in their entireties.

### FIELD OF INVENTION

The present invention relates to a mosaic, in particular for walls, ceilings and floors.

### BACKGROUND

A mosaic typically consists of a plurality of single mosaic elements which are spaced from each other by joints.

Mosaics were used by the ancient Greeks and the Romans more than 2000 years ago for decorating floors and walls. Pictures and designs can be created using mosaics for forming rooms and places. Mosaics can be incorporated into floors, walls and ceilings, and used in indoor areas as well as outdoor areas. Mosaics can be laid in dry rooms or in wet rooms e.g. swimming pools, saunas and steam baths. The manufacture of mosaics requires a high technical skill and a highly skilled installation, which is mastered by only few today.

The present invention relates to the problem of providing a mosaic of the type described above with an improved form, which enables it in particular to achieve additional creative effects in order to increase the acceptance and pleasingness of the mosaic.

### SUMMARY OF THE INVENTION

The invention lies in the general idea of integrating light output elements into the joints which run between the mosaic elements. Whereas the joints of conventional mosaics to not have any creative purpose, the invention enables the creation of focus points by selected arrangement of light output elements in the joints. In this way, a picture or a design inside of the mosaic can be starkly highlighted and accentuated. At the same time an indirect lighting of the surface provided with the mosaic, e.g. a floor, a wall or a ceiling, can be achieved with the light output elements.

The invention combines two completely independent arrangement possibilities in a particular way. The designing of rooms with particular lighting effects is an established method in the field of interior design. It is also well known to design walls, ceilings and floors with mosaics. The combination of these design possibilities results however in a new dimension. Of particular importance is the integration of the light output elements in the mosaic in the area of the joints because the arrangement of the mosaics is not disturbed and, moreover, the up until now ignored joints can be used for accentuating the respective design and/or for creating their own design.

The light output elements can be formed by the light output ends of optical fibers, in particular glass fibers. It is thus possible to position extremely small light points e.g. with a diameter of about 1.5 mm. This is, for example, advantageous if a large number of light output elements are to be positioned in the joints or when only very thin joints are available for example when using mosaics with very small mosaic elements. Other separate light output elements can be used alternatively or additionally within the same mosaic, the respective light output elements being supplied with light through optical fibers. Such light output elements can have practically any form and can, therefore, be tailored to the requirements different mosaics and can be chosen in view of the respective design. The light output elements can, for example, be formed from glass elements, in particular crystal glass elements, which can be cut, uncut or facetted. Furthermore, the light output elements can also be optical lenses or optical prisms. There are in principle no limits to the forms of the light output elements. Only the available joint width limits a dimension of the form of the light output elements.

Light output elements can be used, alternatively or additionally in the same mosaic, which are formed of light emitting diodes and which are provided with electricity though appropriate electric cables. Modern light emitting diodes, LED's, can also have practically any form. In particular, very small LED's can be manufactured. Particularly advantageous is, for example, that LED's can be excited to emit light of different wavelengths, i.e. different colors. Additional effects can therefore be achieved.

In order to efficiently handle and transport big mosaics, it is convenient to assemble the mosaic out of a number of prefabricated mosaic sections, whereby the mosaic elements of such a mosaic section a fixed to a flexible carrier. Known flexible carriers are, for example, fiber matting onto which the mosaic elements are adhered. The joints are then not filled in. According to an advantageous embodiment, the optical fibers and/or the electric cables can be applied to this flexible carrier. The lighting can therefore be already integrated into the prefabricated mosaic sections. This measure simplifies the installation of the mosaic at the desired site.

The flexible carrier is conveniently arranged on a rigid carrier, which eases the handling of the prefabricated mosaic sections.

In a particular embodiment, the said rigid carrier can form a cavity underneath the mosaic elements for laying the optical fibers and/or the electric cable. The mosaic section with the rigid carrier will therefore have a defined thickness, independent of whether and how many optical fibers or electrical cables run through the carrier. This construction simplifies the preparation of the substrate of the respective mosaic, whereby the installation of the mosaic and its adapting onto other coverings s is considerably simplified. Furthermore the rigid carrier is advantageously sufficiently robust that the thickness of the mosaic or the mosaic section is substantially constant over its entire surface and stays constant during the handling and also that it us sturdy enough to be walked on.

An embodiment according to claim 16 can change the optical appearance of the mosaic, in particular in a lasting way, lending the mosaic a certain vibrancy. Furthermore, certain moods can be produced and changed which enables particularly impressive visual effects and a general stimulation of the senses.

Through the embodiments according to claim 18 or 19 the mosaic has an unusual depth effect wholly or in the area of the part-mosaic behind the transparent plate. This depth effect can produce, in connection with the light output elements, particular design possibilities and enables unusual aesthetic effects to be achieved.

According to another specific embodiment according to claims 23 and 24 a watertight cavity can be formed between the at least one transparent plate and the mosaic or part-mosaic arranged behind it, the cavity being at least partially filled with standing or flowing or moving water. The connection of water and light in a mosaic leads to almost spectacular optical effects because the light exiting the light output elements is broken up by the water and is furthermore scattered and reflected. Such a mosaic, that is purposely applied to a floor, can therefore have all over or at least in the area of the part-mosaic a further special optical design element.

Further important features and advantages of the invention can be found in the dependent claims, in the drawings and in the corresponding description of the figures with the drawings.

The above described features and the features to be explained in the following may obviously be used not only in their respectively given combinations but also in other combinations or alone, while falling under the scope of the present invention.

An exemplary embodiment of the invention is shown in the drawings and will be explained in more detail in the following description, whereby the same reference numerals relate to functionally similar or the same components.

### BRIEF DESCRIPTION OF THE DRAWINGS

Shown schematically in,

FIG. 1 is a largely simplified plan view of a section of a mosaic according to the invention;

FIG. 2 to 4 are cross sections of the mosaic in different embodiments;

FIG. 5 is a view from above of a carrier without mosaic elements;

FIG. 6 is a view from below of the carrier;

FIG. 7 is a perspective view of the carrier;

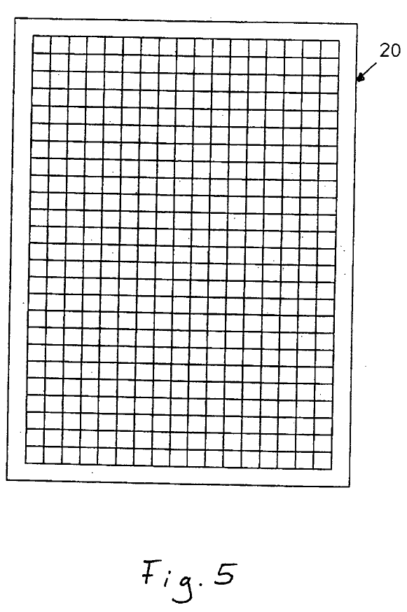

FIG. 8 is a view as in FIG. 7 with mosaic elements although without lighting;

FIG. 9 is a view as in FIG. 8, however with lighting;

FIG. 10 is a side view of the mosaic or a mosaic section during laying;

FIG. 11 is a largely simplified plan view of a section of a mosaic according to the invention;

FIG. 12 is a plan view as in FIG. 11, however in a different embodiment;

FIG. 13 is a cross section through the mosaic in FIG. 12 taken along the line III in FIG. 12; and

FIG. 14 is a cross section as in FIG. 13, however in a different embodiment.

### DETAILED DESCRIPTION

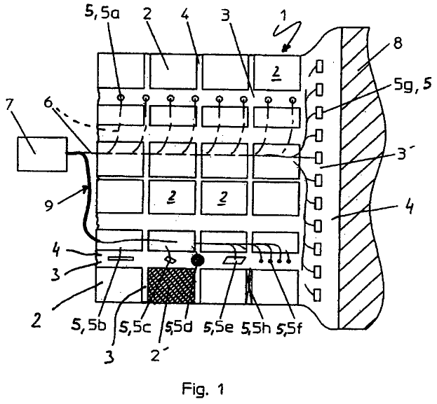

According to FIG. 1, a mosaic 1 includes a plurality of individual mosaic elements 2, which are arranged such that they are spaced apart from each other by joints 3. In the finished and installed condition, the joints 3 are filled with a suitable joint material 4. Usually the joint material 4 is a grout or a silicon or a screed.

The mosaic elements 2 can have vastly differing properties, e.g. they can be made of stone e.g. granite, marble, clay, ceramic, glass, metal or out of plastic.

According to the invention light output elements 5 are arranged in the joints 3. In the shown example a plurality of different light output elements 5 are distinguishable through the letters a to h. By arranging the light output elements 5 inside the joints 3 new, unusual design accents can be applied, which significantly improves the aesthetical possibilities of the mosaic.

As an example some of the light output elements 5f are directly formed by the light exit ends of optical fibers 6. These light exit ends or light output elements 5f therefore have an extremely small cross section and can therefore be positioned in extremely thin joints 3. Furthermore, a large number of such light exit ends or light output elements 5f can be positioned within a joint 3.

In the other forms shown here the light output elements 5 are formed of separate bodies, which are optically coupled with the light exit ends of the optical fibers 6. The optical fibers 6 are preferably glass fibers. Individual light output elements 5 of this kind can be advantageously adapted to the particular design of the mosaic 1 and can be specially chosen for a particular intended effect. For example the light output elements 5 can be glass elements, in particular crystal elements and can be essentially uncut, they are however preferably cut and even facetted. These glass elements can be e.g. pear shaped, semi-spherical or completely spherical. Furthermore the light output elements 5 can form optical lenses of optical prisms in order to achieve further special optical effects. In FIG. 1 a plurality of glass elements 5a, different prisms 5b, 5c, 5e as well as a facetted cut half-sphere 5d are depicted by way of example.

Alternatively it is also possible to form at least some of the light output elements as light emitting diodes, which are appropriately connected to electric cables. Such light emitting diodes (LED) are widely available and can be manufactured in practically any form such that the described effects can also be achieved here.

Light output elements 5 with optical fibers 6 are however preferred as a positional displacement of the light emitting position from the light producing source 7 can be achieved. The light source 7, for example a special projector, feeds the light into the optical fibers 6, for example glass fibers, which leads the light to their light output ends and forms the light output elements 5f or provides the individual light output elements 5 with light.

This form of light transmission takes place without electric current and is therefore suitable for wet areas. Furthermore the optical fiber technique allows the gentle emission of cold light, which is substantially free of damaging UV and IR components. Furthermore, the optical fibers 6 and the light output elements are practically maintenance free and have an almost unlimited life. By contrast, LED's, whereby the light source and the light emission are at the same place, have a long but limited life. Furthermore, the supplying of electricity to LED's in wet areas is more complicated.

FIG. 1 shows a further special feature that the mosaic 1 in the embodiment shown is in laid condition and is bordered at least partially, here on the right edge, by another covering 8. This other covering can be out of, for example, stone slabs (e.g. out of marble or granite, which could be cut with a water jet), tiles (e.g. out of ceramic), mirror and glass tiles, or metal tiles (advantageously laser cut). A border joint 3′ runs between this covering 8 and the mosaic, the border joint being filled advantageously with the same joint material 4 as for the other joints 3.

In the specific embodiment shown here light output elements 5g can be arranged in this the border joint 3. The border of the mosaic 1 can be optically highlighted using these light output elements 5g.

A further special feature shown here is provided by the mosaic element 2′ with the cross hatching. This mosaic element 2′ is formed by a light output element, having correspondingly big dimensions. This light output mosaic element 2′ is also provided with light through an optical fiber 6. By integrating such light output mosaic elements 2′ into the mosaic 1 further special accentuations can be placed in the mosaic 1.

Preferably the light output elements 5 are formed such that their diameter is smaller than the width of the joint. Advantageously the diameters of the light output elements 5 are chosen to be at least half as big as the width of the joints. The light output elements can be thus embedded in the joint material 4 and completely surrounded by the joint material 4 up to the light output side. FIG. 1 shows by way of example another embodiment whereby one of the light output elements 5h has dimensions such that it completely fills in the joint 3 thereby forming itself the joint material.

The optical fibers 6 are laid such that for installing the mosaic 1 they run underneath the mosaic elements 2 to the light output elements 5. Furthermore, for practicability, a plurality of optical fibers 6 can be bundled together in bundles 2 and laid underneath the mosaic elements 2. These bundles 9 can be connected separately or together to the light source 7.

It is clear that the design possibilities of the optical fibers 6 described above and in the following apply similarly to electric cables. The electric cables are, however, not connected to a light source 7, but to a suitable source of electric current.

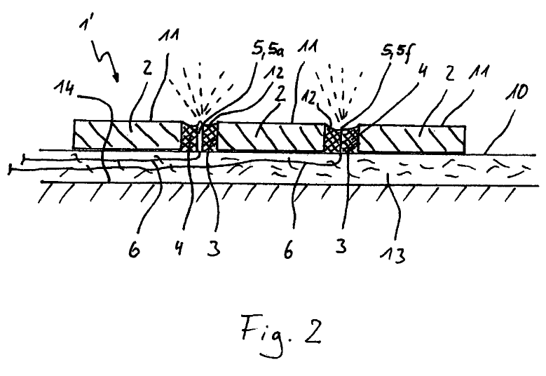

In order to simplify the installation of a big mosaic 1 it is advantageous to divide the mosaic 1 into individual mosaic sections 1′ which are prefabricated and can be assembled in place to form the desired mosaic 1. According to FIGS. 2 to 4, the respective mosaic elements 2 of the whole mosaic 1 or at least of one of the mosaic portions 1′ can be attached to a flexible carrier 10. This flexible carrier 10 consists, for example, a flexible web material, which can be formed of a mesh or a lattice. The mosaic elements 2 are, for example, stuck to the flexible carrier 10. As long as the joints 3 are not filled in the handling of the prefabricated mosaic sections 1′ is particularly easy, this simplifies the installation of the mosaic 1.

In order to prepare for or to simplify the installation of the light output elements 5 the optical fibers 6, for example, can also be attached to the flexible carrier 10. As an example, the optical fibers 6 are also stuck to the flexible carrier 10. When using a web for the flexible carrier 10 the optical fibers 6 can be appropriately embedded into the flexible carrier 10, in particular woven in. This embodiment is suitable for mosaics 1 or mosaic sections 1′ having a small surface area.

It is also apparent from FIGS. 2 to 4 that the light output elements 5 are arranged in the joints 3 according to a preferred construction such that they positioned substantially flush or lightly sunken with respect to the surface 11 of the mosaic elements 2, or such that they are flush or lightly sunken relative to the surface 12 of the joint material 4. The light output elements 5 are therefore safely integrated in the mosaic 1 such that it can be walked on.

In principle, according to the embodiment in FIG. 2, a mosaic section 1′ with e.g. a relatively small surface area can be stuck onto a respective substrate 14 with an appropriate grout or an adhesive 13. Depending on the mosaic 1 the substrate 14 can be a floor, a ceiling or a wall. Because the individual optical fibers 6 only have a relatively small cross section a relatively small mosaic section 1′ can be laid down in the conventional way. In order that there is no thick bundling of the individual optical fibers 6 up to the light source 7 the optical fibers 6 can be, for example, fanned out next to one another along the carrier 10. The individual optical fibers 6 can be fixed with adhesive tape or an adhesive to the flexible carrier 10 in order to improve the handling of the prepared mosaic sections 1′.

For mosaics 1 or mosaic sections 1′ having a larger surface area it is advantageous to place them together with the flexible carrier 10, in particular loosely, onto a rigid carrier 20. The handling is further improved with use of the rigid carrier 20, which preferably provides a support for the mosaic sections 1′ or the mosaic 1 which can be walked on.

According to FIG. 3, the rigid carrier 20 is designed such that a cavity 15 is formed underneath the mosaic elements. The rigid carrier 20 is formed, for example, by a mesh structure e.g. out of wire. The cavity 15 enables the optical fibers 6 to be laid within the rigid carrier 20, whereby this is carried out very easily. The rigid carrier 20 ensures at the same time a constant thickness for the mosaic section 1′, which considerably reduces the effort required to install the mosaic 1. The optical fibers 6 can be put together in bundles 9 and therefore more easily laid in the cavity 15. Using the rigid carrier 20 big and heavy prepared mosaic sections 1′ or mosaics 1 can be easily transported.

It is also possible that the cavity 15 is filled with a suitable filling material after all the optical fibers 6 have been put in place, the optical fibers 6 being therefore embedded in the filling material. Such a filling material serves, for example, for damping impact noise and can also contribute to the thermal insulation. The filling material is, for example, a thin flowing adhesive screed. At the same time of filling in the cavity 15 the joints 3 can also be at least partially filled, if a suitable filling or joint material 4 is used. This means that the filling material serves also as a joint material 4 at least in a certain area.

At the same time the rigid carrier 20 can serve as a support for the individual light output elements 5, which considerably simplifies their positioning in the joints 3 before they are filled.

According to FIG. 4, a separate support 16 for each light output element 4 can be provided for positioning the light output elements 4 or for positioning a plurality of light output elements 4 at the same time a common support 16 can be provided. Such a support 16 is attached for example to the rigid carrier 20. This support 16 can also be directly attached to the mosaic elements 2 and/or the flexible carrier 10. The support 16 is, for example, wedged into the joint 3 and/or in the rigid carrier 20 or is stuck to the mosaic elements 2 or to the flexible carrier 10. The support 16 is adapted for positioning the respective light output element 5 and can therefore be used for prefabricating the respecting mosaic section 1′. Using such a support 16 the light output elements 5 can be positioned individually or bundled together in the joints 3 in the desired way. For example, the light output elements 5 should be centrally located in the joint 3 in relation to neighboring mosaic elements 2. This positioning using the support 16 before filling the joints 3 with the joint material 4 is particularly advantageous, because it reduces considerably the effort required to install the mosaic 1. A support 16 for a plurality of light output elements 5 can be formed e.g. as a flexible strip.

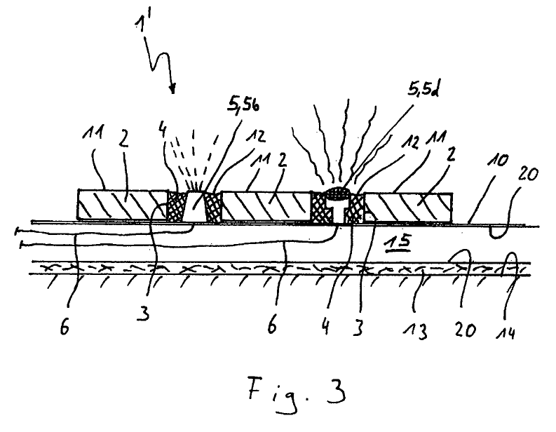

According to FIG. 5 the rigid carrier 20 of the mosaic 1 or of the mosaic section 1′ can be formed of a relatively stiff wire mesh e.g. out of metal, thus forming a relatively stable support structure for the mosaic elements 2 which are laid upon it.

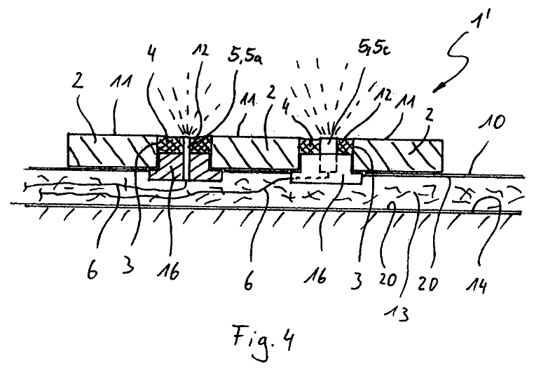

According to FIG. 6, the underside of the rigid carrier 20 can be provided with spacer elements 17, which project downwards from the underside of the rigid carrier 20. These spacer elements 17 can be provided in a relatively large number, as shown, and can be stilt-formed and can provide in particular a support, which can be walked on, for the rigid carrier 20 on the substrate 14.

According to FIG. 4, using spacer elements 17, the rigid carrier 20 can be placed on the substrate 14 forming the cavity 15 described above. A chosen length of the spacer elements 17 results in a mosaic 1 having a predefined thickness, which considerably simplifies its integration into bordering floor coverings, hence simplifying the installation.

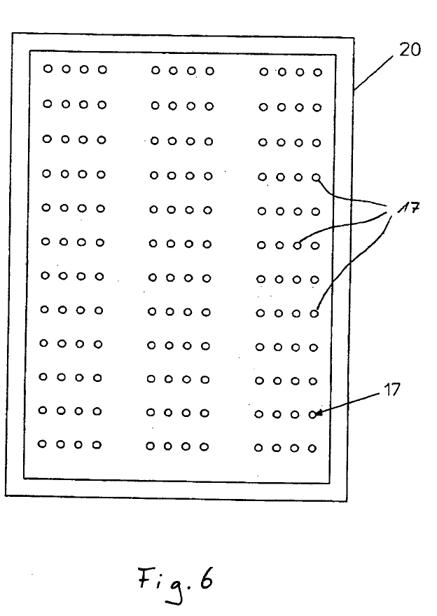

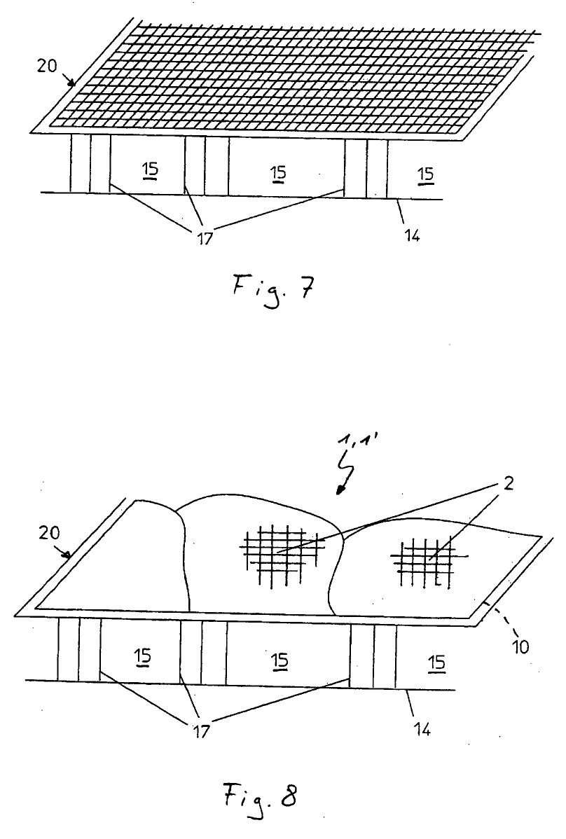

FIG. 8 shows the rigid carrier 2 with mosaic elements 2 arranged upon it to form a mosaic or a mosaic section 1′. The mosaic elements 2 are normally attached to the flexible carrier 10, e.g. by adhesive, whereas the assembly of the flexible carrier 10 and the attached mosaic elements 2 are laid loosely onto the rigid carrier 20. The mosaic 1 or the mosaic sections 1′ can therefore be prefabricated, e.g. in a factory, separately from the end installation location.

Whereas in FIG. 8 no built-in light output elements 5 are shown, FIG. 9 shows, by way of an example, the integration of the light output elements 5. The light output elements 5 are advantageously introduced from underneath into the joints 3. To simplify the assembly at least one assembly bench 18 can be used, onto which the carrier 10 is placed. By selecting appropriate dimensions for the at least one assembly bench 18 the manipulation of the light output elements 5 and in particular of the optical fibers 6 on the underside of the carrier 10 underneath the mosaic elements 2 can be considerably simplified.

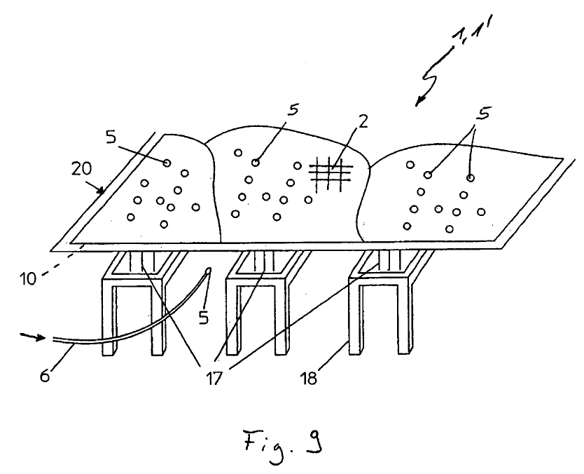

FIG. 10 shows a side view of a finished prefabricated mosaic 1 or of a finished prefabricated mosaic section 1′. It is clearly visible how a plurality of optical fibers 6 is brought together in a bundle 9. It is also clearly recognizable how all the optical fibers 6 can be accommodated inside the cavity 15 underneath the mosaic elements 2. According to the preferred setup described here the prefabricated mosaic 1 or the prefabricated mosaic section 1′ including the lighting components (light output elements 5 and optical fibers 6) and the rigid carrier 20 can be placed in a more or less fluid bed 19 of adhesive, grout, resin or screed.

The cavity 15 is substantially completely filled through this, which results at the same time in a connection of the rigid carrier 20 to the substrate 14 and a connection of the mosaic elements 2 to the rigid carrier 20. The bed 19 is advantageously formed such that a sufficient adhesive effect between the substrate 14 (e.g. out of concrete), the rigid carrier 20 (e.g. out of metal) and the mosaic elements 2 (e.g. out of ceramic, glass, marble, granite or metal) can be created. For example, the bed 19 can be a type of fluid-adhesive-screed, preferably based on a reaction resin into which quartz sand can be mixed. Advantageously the substrate 14 is pre-treated, e.g. with an epoxy resin coating, in order to make it watertight.

By appropriately dimensioning the bed 19 the joints 3 can be filled at the same time as the mosaic 1 or mosaic section 1′ is put in place, if with a sufficient bed thickness the bed material penetrates the joints 3 from below and fills them.

The optical fibers 6 or the bundles 9 can be led to the at least one light source 7 along the border of the mosaic 1, for example, with an appropriate cable channel. The light source 7 being advantageously easily accessible outside of the mosaic, e.g. for a floor mosaic 1 in or at an adjacent wall.

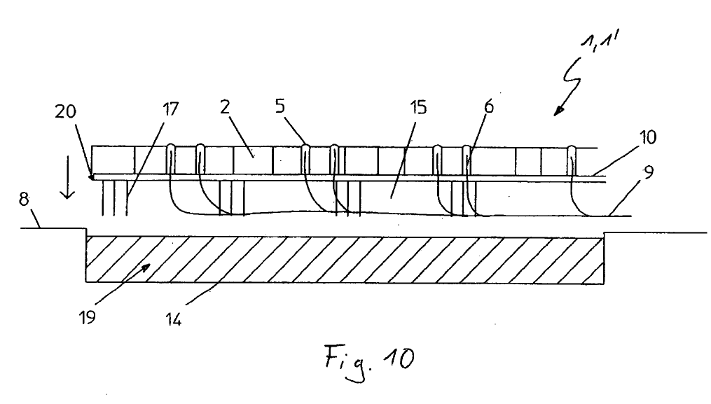

According to FIG. 11 the mosaic 1 consists again of a plurality of individual mosaic elements 2, which are arranged such that they are respectively spaced from each other by joints 3. In the finished installed condition these joints 3 are filled with a suitable joint material. For the joint material grout or silicon or a fluid adhesive screed is usually used. The mosaic elements 2 can have greatly varying properties, for example they can be out of stone, e.g. granite or marble, out of ceramic, glass, metal or plastic.

As for the above described embodiments light output elements 5 are arranged in the joints 3. For the sake of clarity, the light output elements 5 in the embodiments shown here are only designated with points at the nodes of the joints 3.

It is clear that the light output elements 5 must not necessarily be arranged at the nodes of the joints 3 for a specific design. Furthermore, the light output elements 5 can by all means have clearly smaller dimensions than the width of the joints 3. By arranging the light output elements 5 inside of the joints 3 new, unusual design accents can be placed, which significantly improves the aesthetic possibilities of the mosaic.

For example, the light output elements 5 can be formed directly by the light output ends of the optical fibers 6. The optical fibers 6 are preferably glass fibers.

The light output ends or light output elements 5 therefore have an extremely small cross section and can therefore be placed in extremely thin joints 3. Furthermore a large number of such light output ends or light output elements 5 can be positioned inside of the joint 3.

In an embodiment, which is not shown, at least one of the mosaic elements 2 can be replaced by an optical element which is lit from the side or from beneath. For lighting, a light output element 5 of the type described above can be used, which is appropriately not led through the joint to the visible side of the mosaic 1. For lighting of the optical element a light output element 5 can, for example, be led to the optical element from below or sideways via one of the joints 3. It is also possible at least to lead such a light output element 5 sideways underneath the optical element and to divert the emitted light upwards to the optical element with appropriate diversion means, in order to indirectly light the optical element from below. The optical element can be preferably a cut glass which becomes as a prism and produces a refraction, bending and/or scattering of the light supplied to the viewable side of the mosaic 1. With a multi-facetted cut particularly impressive optical effects can be thus achieved. A particularly strong refraction of the light can be achieved by an exclusive design whereby the optical element is formed by a cut diamond.

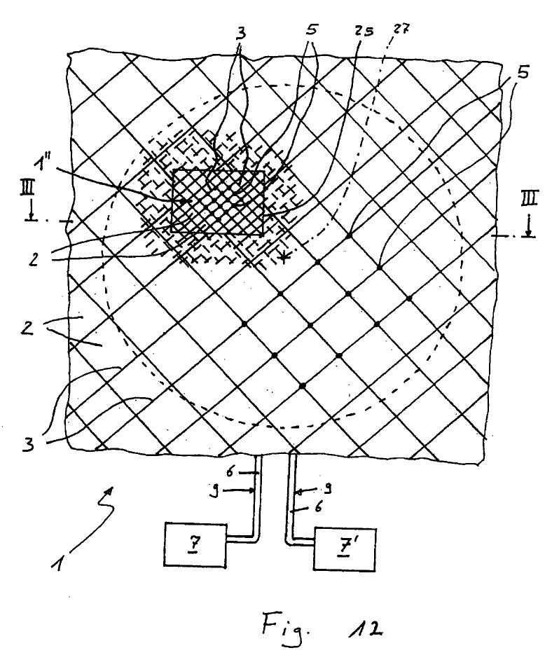

In principle the optical element can be arranged in a mosaic plane (see position 24 in FIG. 13) flush with the neighboring mosaic element 2. A special depth effect can be achieved with the optical element when the optical element is set back relative to the viewable side of said mosaic plane 24.

Referring to FIG. 11, the light source 7 is advantageously coupled to a controller 21, which serves to control the light source 7. The light source 7 is designed such that the light emission of the light output elements 5 is variable with regards to the color and/or intensity and/or and the time the light is on. Preferably the controller 21 is also designed such that the light emission of the light output elements 5, with regards to the color and/or intensity and/or and the time the light is on, can be varied. For this the light output elements 5 can be controlled individually or in groups.

In a further embodiment the controller 21 can be connected to an audio device 22 and/or with a video device 23. The audio device 22 is suitable for playing music and comprises, for example, a CD-player, a suitable amplifier and loud speakers. The controller 21 can be designed such that it controls the light output elements 5 in synchronously with the music played on the audio device 22. In contrast the video device 23 is suitable for showing pictures and is therefore equipped with, for example, a DVD-player and a projector. The controller 21 can also be designed such that it controls the light output elements 5 synchronously with the pictures showed by the video device 23. It is obvious that the data carrier to be played by the video device 23, for example a DVD, can also contain audio signals, whereby a connection of the video device 23 with the audio device 22 enables the playing of pictures and sound at the same time. It is also common to integrate the essential components of an audio device 22 and a video device 23 together.

In the embodiment of the mosaic 1 containing light diodes the light source 7 is not required because the respective light diodes provide the light source themselves. In such an embodiment a variation of the light intensity and duration of light for the individual or bundled together light diodes can also be achieved by appropriately controlling the LEDs. In particular there are multicolor light diodes which, dependent on the current flowing through them, can emit different wavelengths (colors).

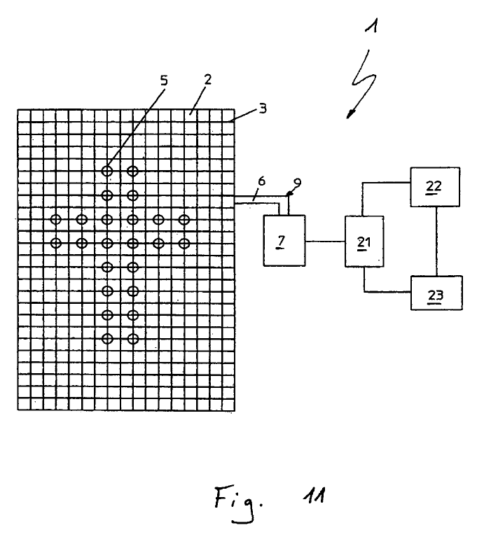

Such a mosaic 1 can, in principle, follow practically any three dimensional structure of a floor, wall or ceiling. According to FIGS. 12 and 13 it is however normal that at least a section of the mosaic 1 lies in one plane. This mosaic plane is indicated in FIG. 13 by a dashed line and is designated by the reference numeral 24. In a preferred embodiment the mosaic 1 can comprise a part mosaic 1″ in the section lying in one plane. This part mosaic 1″ is arranged set back in relation to the mosaic plane 24 on the viewable side of the mosaic 1, which is opposed to the substrate of the mosaic 1. In FIG. 13 the part mosaic 1″ is therefore arranged below the mosaic 1. Furthermore the part mosaic 1″ is covered with a transparent plate 25 which lies in the mosaic plane 24. The plate 25 is preferably designed such that it can be walked on and/or fitted and consists, in particular, out of glass. Through this construction the mosaic 1 has a certain three-dimensional effect, because the offset arranged part mosaic 1″ gives a depth effect. This depth effect can also by increased when light output elements 5 are also arranged in the joints 3 of the part mosaic 1, the light output elements 5 being provided with a separate light source 7′, for example.

According to a particularly advantageous further embodiment the part mosaic 1″ can be placed on a separate support board 26, which is rotatably supported around a pivot axis. The pivot axis 27 is arranged, in particular perpendicularly, to the mosaic plane 24. The part mosaic 1″ is therefore arranged to be rotatable around the pivot axis 27 relative to the rest of the mosaic 1. It is obvious that an appropriate rotating device, for example an electric motor, can be provided in order to rotate the part mosaic 1″. With this construction there is the possibility to vary the set back part mosaic 1″ by rotating it, which allows further special visual effects to be achieved inside of the mosaic 1.

In principle, the part mosaic 1″ and the plate 25 can be congruently designed, whereby the rotation axis 27 is arranged centrally with respect to the part mosaic 1″ and the plate 25. According to the embodiment shown here the part mosaic 1″ parallel to the mosaic plane 24 can have a bigger surface area than the plate 25. This results in always only a portion of the part mosaic 1″ being recognizable through the plate 25 from the viewable side of the mosaic 1. By an eccentric arrangement of the rotation axis 27 relative to the plate 25 only the respective viewable portion of the part mosaic 1″ is changed by rotating the part mosaic 1″. This feature also enables special new effects. In contrast the pivot axis 27 is preferably centrally located in relation to the part mosaic 1″.

In order not to affect the option of walking on the whole mosaic 1 in the region of the part mosaic 1 the plate 25 is preferably arranged such that it completes the mosaic 1 in the mosaic plane 24 in a flush and gap free manner.

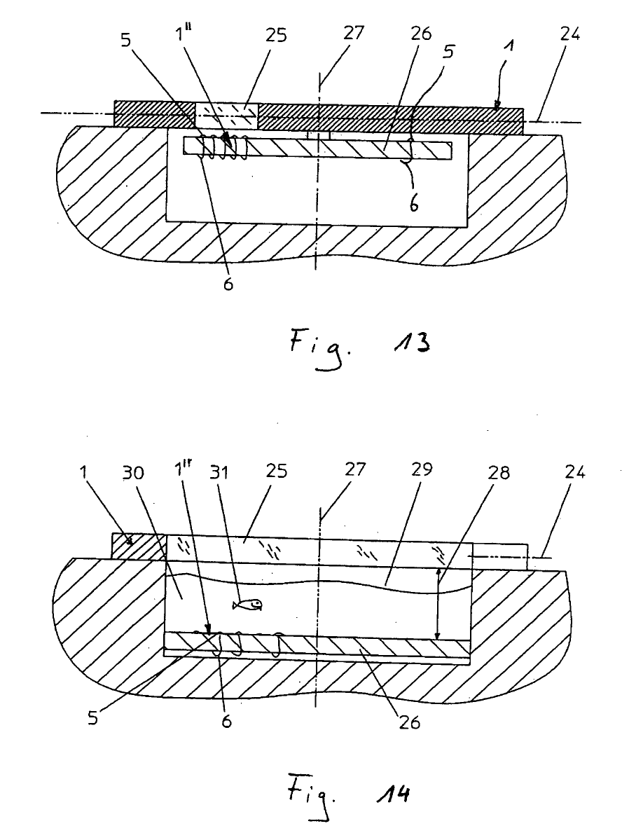

FIG. 14 shows a further embodiment of the mosaic 1 which has a part mosaic 1″ which is set back relative to the mosaic plane 24. In contrast to the embodiment in FIGS. 12 and 13, in the embodiment according to FIG. 14 there is a gap 28 between the part mosaic 1″ and the plate 25 which is designed large enough so that there is a cavity between the part mosaic 1″ and the plate 25. The gap 28 is, for example, at least 10 cm, it can also be however at least 20 cm.

In a preferred embodiment the gap 28 is 30 cm. In forming the cavity 29 between the plate 25 and the part mosaic 1″ the depth effect in the area of the part mosaic 1″ is considerably increased.

According to a particularly advantageous embodiment the cavity 29 can be watertight, which allows the cavity 29 to be at least partially filled with water. The water 30 can be standing, similar to a pond, or flowing like a stream or generally moving. Moving water 30 can be produced, for example, by a wave machine (not shown). The filling of the cavity 29 with water 30 results again in special optical effects due to reflections and refraction. The combination with the light output elements 5, which can also be arranged here in the part mosaic 1″, gives a brilliant play of colors and effects. A special advantage of using optical fibers also becomes apparent because the optical fibers 6 can be arranged in a wet area or even underwater without further adaptation.

It is clear that in the area of the cavity 29, in particular relating to with the water 30, further special effects can be integrated into the mosaic 1. Light output elements can be, for example, integrated into the side walls of the cavity 29. The side walls of the cavity 29 can also be provided with a section of the mosaic 1. It is also possible to integrate a mist generator, which works with ultrasound, into the part mosaic 1″ in order to create special effects with mist. Furthermore it is possible to form the cavity 29 into an aquarium, which is depicted in FIG. 14 by a fish 31 swimming in water 30.

Furthermore the embodiments in FIGS. 11 to 14 can be combined with each other in appropriate ways. In particular, in the embodiment according to FIG. 14 the part mosaic 1″ can be mounted rotationally. Furthermore, the light output elements 5 of the part mosaic 1″ according to the embodiment in FIGS. 12 to 14 can be controlled synchronously to the played music or generally to sound and/or pictures.

Although in relation to the embodiments in FIGS. 12 to 14 only mosaics 1 or 1″, which are a part mosaic 1″ of a whole mosaic 1, are arranged under a plate 25, it is also obvious an embodiment where the whole mosaic 1 is covered by a transparent plate 25 or a plurality of transparent plates 25 is also covered by the present invention. In particular such a covered mosaic 1 similar to the embodiment in FIGS. 12 and 13 can also be rotatably mounted and/or, similar to the embodiment in FIG. 14, provided with a cavity 29 between its viewable side and the at least one plate 25 and/or which is water resistant or watertight. In filling the cavity 29 with water 30 the water 30 in the cavity 29 can in principle be lit in any way with light, e.g. with a conventional swimming pool lighting. A lighting of the viewable side of the mosaic 1 is however preferred, in particular via light output elements 5 provided in the joints 3. Furthermore, for such a covered mosaic 1, individual mosaic elements 2 can be replaced by lit-up optical elements. The lighting of the covered mosaic 1 can also be synchronized with the playing of music or generally from sound and/or pictures.

1. A mosaic, in particular for walls, ceilings or floors, comprising a plurality of individual mosaic elements spaced apart from each other by joints, wherein a plurality of light output elements are arranged in the joints.

2. The mosaic according to claim 1, wherein at least one of the light output elements is formed by light output ends of optical fibers.

3. The mosaic according to claim 2, wherein the optical fibers run underneath the mosaic elements to the light output elements.

4. The mosaic according to claim 2, wherein the mosaic elements of the mosaic or of a mosaic section of a mosaic made of a plurality of pre-assembled mosaic sections are attached to a flexible carrier, and wherein the optical fibers are attached to the flexible carrier or a rigid carrier onto which the flexible carrier with the mosaic elements is laid.

5. The mosaic according to claim 4, wherein the rigid carrier forms a cavity underneath the mosaic elements for accommodating the optical fibers.

6. The mosaic according to claim 4, wherein the rigid carrier comprises spacer elements on the side facing away from the mosaic elements for forming a cavity when placing the rigid carrier on a substrate.

7. The mosaic according to claim 5, wherein the cavity is filled with a filling material, and wherein the optical fibers are embedded into the filling material.

8. The mosaic according to claim 1, wherein the joints are filled with a joint material which, for at least one joint, is provided by at least one of the light output elements.

9. The mosaic according to claim 1, wherein at least one of the light output elements has a diameter which is smaller than the width of the joint and at least one half of the width of the joint.

10. The mosaic according to claim 1, wherein the light output elements comprise one or more of the following: cut or facetted glass elements, crystal glass elements, optical lenses, optical prisms, bulbs, semi-spheres or spheres.

11. The mosaic according to claim 1, wherein at least one of the light output elements is positioned in the joints individually or in groups respectively with a support.

12. The mosaic according to claim 1, wherein the light output elements are flush or lightly set back in relation to the surface of the mosaic elements or in relation to the surface of a joint material filling the joints and providing the bed for the light output elements.

13. The mosaic according to claim 1, wherein at least one of the mosaic elements is formed by a correspondingly dimensioned light output element.

14. The mosaic according to claim 1, wherein the mosaic in its laid condition is at least partly bordered by another covering, whereby a border joint runs between this covering and the mosaic, and that light output elements are arranged in the border joint.

15. The mosaic according to claim 2, wherein the optical fibers are combined into a bundle which runs underneath the mosaic elements and is connected to a common light source or to an electricity source.

16. The mosaic according to claim 1, wherein a controller is provided for controlling the light output elements or for controlling a light source connected with the light output elements, wherein at least one of the controller, the light source and the light output elements being adapted for varying at least one of the color, the intensity and the duration of the light emission from the light output elements.

17. The mosaic according to claim 16, wherein the controller is coupled with an audio device for emitting sound, and the light output elements are controlled synchronously to the sound emitted from the audio device.

18. The mosaic according to claim 1, wherein the mosaic is covered on its viewable side with at least one transparent plate.

19. The mosaic according to claim 1, wherein at least a section of the mosaic extends in one plane, and that the mosaic in the section of the plane comprises a part mosaic, which is set back relative to the mosaic plane in relation to a viewable side of the mosaic and is covered with a transparent plate extending in the mosaic plane.

20. The mosaic according to claim 18, wherein the transparent plate can be walked.

21. The mosaic according to claim 18, wherein the covered mosaic or the part mosaic is rotationally mounted in relation to rotational axis projecting from a mosaic plane.

22. The mosaic according to claim 21, wherein the part mosaic parallel to the mosaic plane extends further than the plate, such that only a portion of the part mosaic can be seen through the plate, the rotational axis being eccentric relative to the plate and centered relative to the part mosaic, the plate completing the mosaic in a flush and gap free manner.

23. The mosaic according to claim 18, wherein a gap is provided of at least 10 cm between the covered mosaic or the part mosaic and the plate, whereby a cavity is formed between the covered mosaic and the plate or between the part mosaic and the plate.

24. The mosaic according to claim 23, wherein the cavity is formed watertight and is at least partially filled with standing or flowing or moving water.

25. The mosaic according to claim 24, wherein the cavity is designed as an aquarium.

26. The mosaic according to claim 18, wherein the covered mosaic or at least the part mosaic is provided with light output elements arranged in the joints.

27. The mosaic according to claim 1, wherein at least one mosaic element of the mosaic is replaced by an optical element which is lit from the side or from underneath or from both the side and underneath.

28. The mosaic according to claim 27, wherein at least one said optical element is arranged flush in the mosaic plane in which the neighboring mosaic elements are arranged.

29. A method of installing a mosaic, wherein the mosaic comprises:
a plurality of individual mosaic elements spaced apart from each other by joints, wherein a plurality of light output elements are arranged in the joints;
wherein at least one of the light output elements is formed by light output ends of optical fibers,
wherein the optical fibers run underneath the mosaic elements to the light output elements,
wherein the mosaic elements of the mosaic or of a mosaic section of a mosaic made of a plurality of pre-assembled mosaic sections are attached to a flexible carrier, and that the optical fibers are attached to the flexible carrier or a rigid carrier onto which the flexible carrier with the mosaic elements is laid,
wherein the rigid carrier forms a cavity underneath the mosaic elements for accommodating the optical fibers,
wherein the method comprises the step of laying the mosaic or the mosaic section, having mosaic elements arranged on the flexible carrier and having the flexible carrier arranged on the rigid carrier and having light output elements provided in the joints and having optical fibers laid in the cavity, onto a bed provided on a substrate, the bed being of a fluid grout, adhesive, resin or screed.

30. The mosaic according to claim 1, wherein at least one of the light output elements is connected to the light output ends of optical fibers.

31. The mosaic according to claim 1, wherein at least one of the light output elements is provided by light emitting diodes, which are connected to electric cables.

32. The mosaic according to claim 1, wherein the joints are filled with a joint material and wherein for at least one of the joints the light output elements are embedded in the joint material.

33. The mosaic according to claim 16, wherein the controller is coupled with a video device adapted for displaying graphics, and the light output elements are controlled synchronously with the graphics displayed by the video device.

34. The mosaic according to claim 18, wherein the transparent plate is a glass plate.

35. The mosaic according to claim 27, wherein at least one such optical element is arranged set back in relation to the mosaic plane of the viewable side of the mosaic where the neighboring mosaic elements are arranged.

36. The mosaic according to claim 27, wherein the optical element is a cut glass prism or cut diamond.
